(19) United States
(12) Patent Application Publication
(10) Pub. No.: US 2011/0253516 A1
(43) Pub. Date: Oct. 20, 2011

(54) Modular Sensor Switch

(75) Inventors: Armando Figueroa, Carlsbad, CA (US); Eric J. Fournier, Carlsbad, CA (US); Jennifer E. Holland, Carlsbad, CA (US)

(73) Assignee: The Watt Stopper, Inc.

(21) Appl. No.: 13/039,793

(22) Filed: Mar. 3, 2011

Related U.S. Application Data
(60) Provisional application No. 61/310,941, filed on Mar. 5, 2010.

(51) Int. Cl. H01H 9/02

(52) U.S. Cl. 200/297

(57) ABSTRACT

A modular sensor switch is formed to include the sensor and electrical control elements in a base module which is covered by a removable and replaceable cover plate module that may be aesthetically coordinated with a suitable switch or cover plate. The cover plate module may be changed by a user without the services of an electrician. The cover plate module includes at least one sensor cover and at least one manual switch activator element that may be formed to aesthetically coordinate with a switch plate cover to create a unified decorative effect for the combined switch plate cover and cover plate module.

### RELATED APPLICATIONS

This application claims priority from copending U.S. Provisional Patent Application 61/310,941 filed Mar. 5, 2010.

### FIELD OF THE INVENTIONS

The inventions described below relate to the field of sensor switches and more specifically to wall-mountable sensor switches having a modular assembly to allow a user to change a cover plate module of the sensor switch.

### BACKGROUND OF THE INVENTIONS

Wall switches used to control lighting and other electrical items are available in a variety of colors for decorative coordination. Often, decoration in a room may be changed, requiring a change to the color of the switch. It is possible to physically replace the switch with a different color, but this requires purchase of a new switch and a skilled electrician to correctly remove and replace old switches with new switches.

Wall switch sensors, sometimes referred to as sensor switches typically incorporate a manual switch and vacancy/occupancy sensing technology, which is typically comprised of infrared (IR), ultrasonic (US), or dual technology combining either IR and US or IR and acoustic monitoring. These sensor switches are used to conserve energy and are often costly.

These wall switch sensors become decoration problems when decoration in a room changes because wall switch sensors are only offered in a few colors and have a high replacement cost. The user must physically change the switch in order to have a different one of the few different colors, which again may require the services of a skilled electrician and incur additional cost for replacing the sensor switch.

### SUMMARY

A modular sensor switch is formed to include the sensor and electrical control elements in a base module which is covered by a removable and replaceable cover plate module that may be aesthetically coordinated with a suitable switch or cover plate. The cover plate module may be changed by a user without the services of an electrician. The cover plate module includes at least one sensor cover and at least one manual switch activator element that may be formed to aesthetically coordinate with a switch plate cover to create a unified decorative effect for the combined switch plate cover and cover plate module.

A modular sensor switch for automatically and or manually controlling electricity to a load (a lamp for example) includes a base module sized and dimensioned for mounting in a standard electrical switch box. The base module includes a housing enclosing an electronic assembly module. The electronic assembly module has a switch to enable manual control of electric energy applied to a load, at least one sensor for detecting changes in occupancy and or other conditions within an area near the modular sensor switch and a control circuit. The sensor generates one or more signals in response to changes in occupancy or other condition. The control circuit controls the switch to provide automatic control of electric energy applied to the load corresponding to the signals from the sensor. The base module also includes an intermediate plate engaging the housing, the intermediate plate securing a yoke and an insulator between the intermediate plate and the electronic assembly module. Finally, a cover plate module is detachably coupled to the base module. The cover plate module includes at least one sensor lens cover and at least one switch activator element.

### BRIEF DESCRIPTION OF THE DRAWINGS

FIG. 1 is a perspective view of a sensor switch with a modular replaceable cover plate.

FIG. 2 is an exploded perspective view of the sensor switch of FIG. 1 with the cover plate removed.

FIG. 3 is an exploded perspective view of the major elements of the sensor switch of FIG. 1.

FIG. 4 is a perspective view of an intermediate plate module for the sensor switch of FIG. 1.

FIG. 5 is a perspective view of the back of a cover plate module for the sensor switch of FIG. 1.

FIG. 6 is s side view of the cover plate module of FIG. 5.

FIG. 7 is an exploded perspective view of the cover plate module of FIG. 5.

### DETAILED DESCRIPTION OF THE INVENTIONS

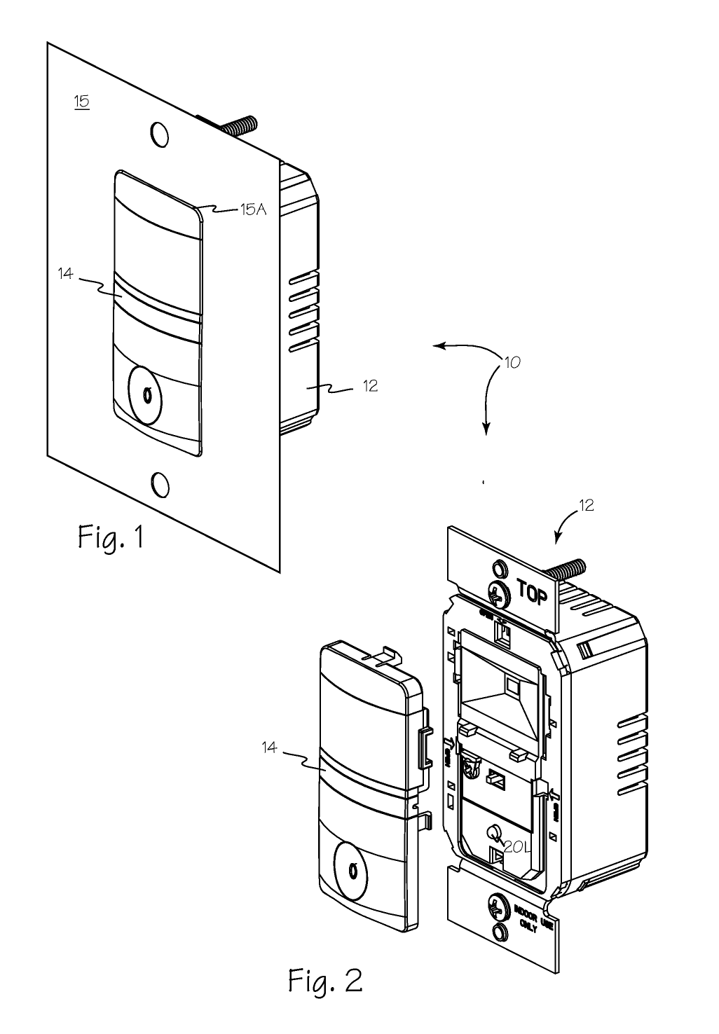

Modular sensor switch 10 of FIGS. 1 and 2 includes base module 12 and cover plate module 14 and faceplate 15. Cover plate module 14 is sized and dimensioned to fit within opening 15A of face plate 15. Face plate 15 and cover plate module 14 may be colored, shaped, decorated or otherwise coordinated for decoration or design esthetics and they may easily be replaced without the services of an electrician. Face plate 15 may also be called a cover plate and or a switch plate.

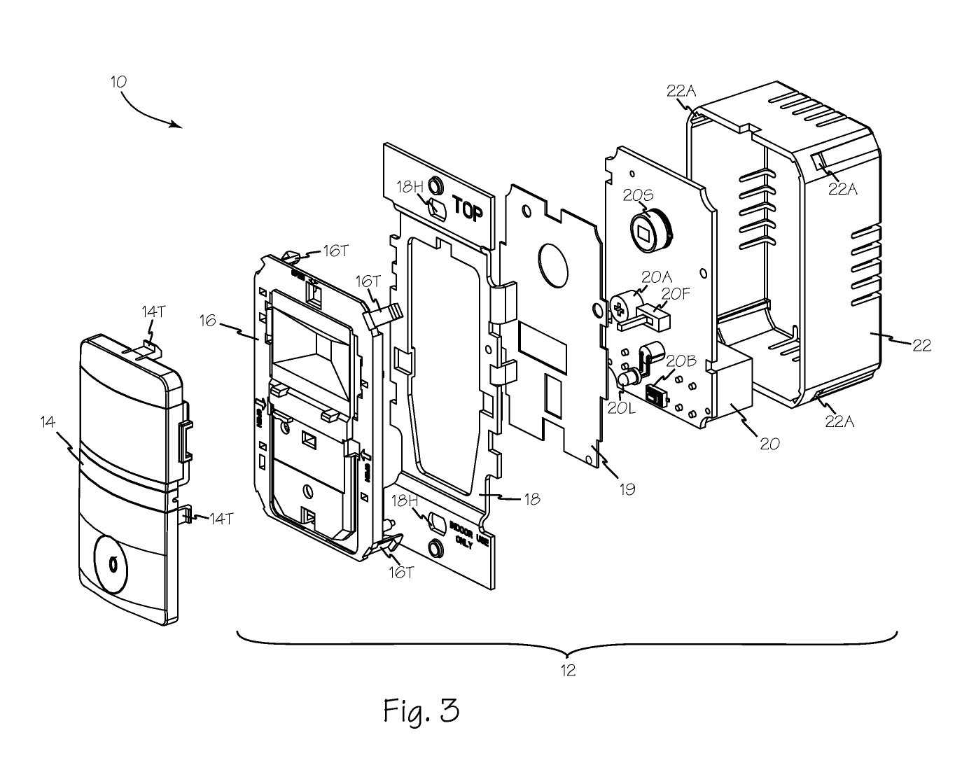

Referring now to FIG. 3, base module 12 includes intermediate plate 16, yoke 18, insulator 19 and electronics assembly 20 fitted within rear enclosure 22. Cover plate module 14 removably engages base module 12. A screw or other suitable fastener may be used to secure electronics assembly 20 and insulator 19 to yoke 18. The yoke-insulator-electronics assembly is placed into the rear enclosure, and intermediate plate 16 is secure over the yoke-insulator-electronics assembly, using locking tabs 16T to engage corresponding lock elements such as locks 22A in rear enclosure, to form base module 12. Any other suitable fasteners or fastening means may be used to secure the elements of base module 12 together. Base module 12 is generally within a code approved electrical box and secured with screws or other suitable fasteners at the top and bottom of the yoke such as through holes 18H. Once base module 12 is secured within an electrical box, the user does not have reasonable access to locking tabs 16T on the intermediate plate preventing a user from separating intermediate plate 16 from rear enclosure 22.

Cover plate module 14 is removably attached to intermediate plate 16 with any suitable elements such as locking tabs 14T. In an alternative configuration, a cover plate module may be attached to the intermediate plate using small screws or a pin/slide arrangement accessible underneath a removable or movable (e.g., hinged or via slides) PIR lens.

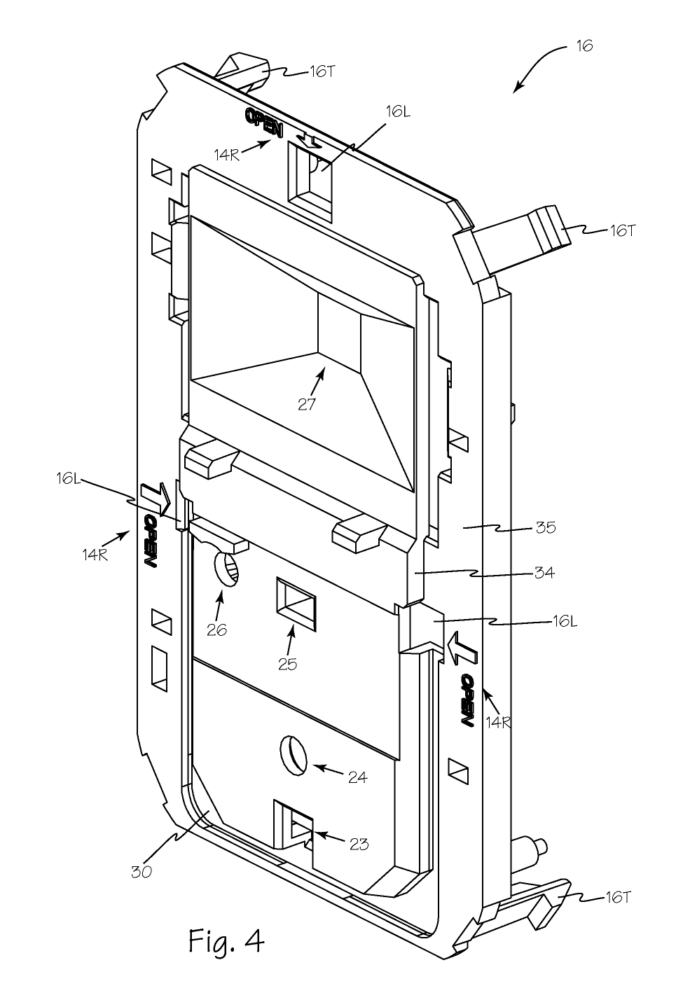

Referring now to FIG. 4, intermediate plate 16 performs a number of functions. First, it encloses electronics assembly 20 within rear enclosure 22 to prevent a user from inadvertently contacting live high voltage. Second, it provides removal instructions 14R for removing cover plate module 14 by showing arrows and the word “OPEN” at engagement locations 16H for instructing a user where to unlock the cover plate for removal. Third, it provides access holes for sensors, user controls and displays, some of which are not accessible when the cover plate is in place. For example, opening 23 accommodates the push button actuator 23A to enable contact with switch 20B, indicator opening 24 is sized to accommodate LED indicator 20L, function select switch 20F and sensitivity adjustment 20A may be accessed through access ports 25 and 26 respectively, and any suitable sensor such as PIR sensor 20S is accessible through sensor access port 27. Sensor access port 27 may adopt any suitable shape to form an optical guide for infrared light or the energy detected by the selected sensor. Sensors may include one or more of a passive infrared detector, an infrared sensor, an audio sensor, an ultrasonic sensor and a photo sensor.

Lower section 30 of intermediate plate 16 is recessed to allow switch activator elements 32 of the cover plate module considerable movement when the switch activator element 32 of the cover plate is pressed to actuate switch 20B. Fulcrum area 34 is raised above surface 35 of the intermediate plate to fill in the area underneath of the cover plate. Without raised fulcrum area 34, the user could see a gap between cover plate module 14 and intermediate plate 16 that may detract from its cosmetic appearance.

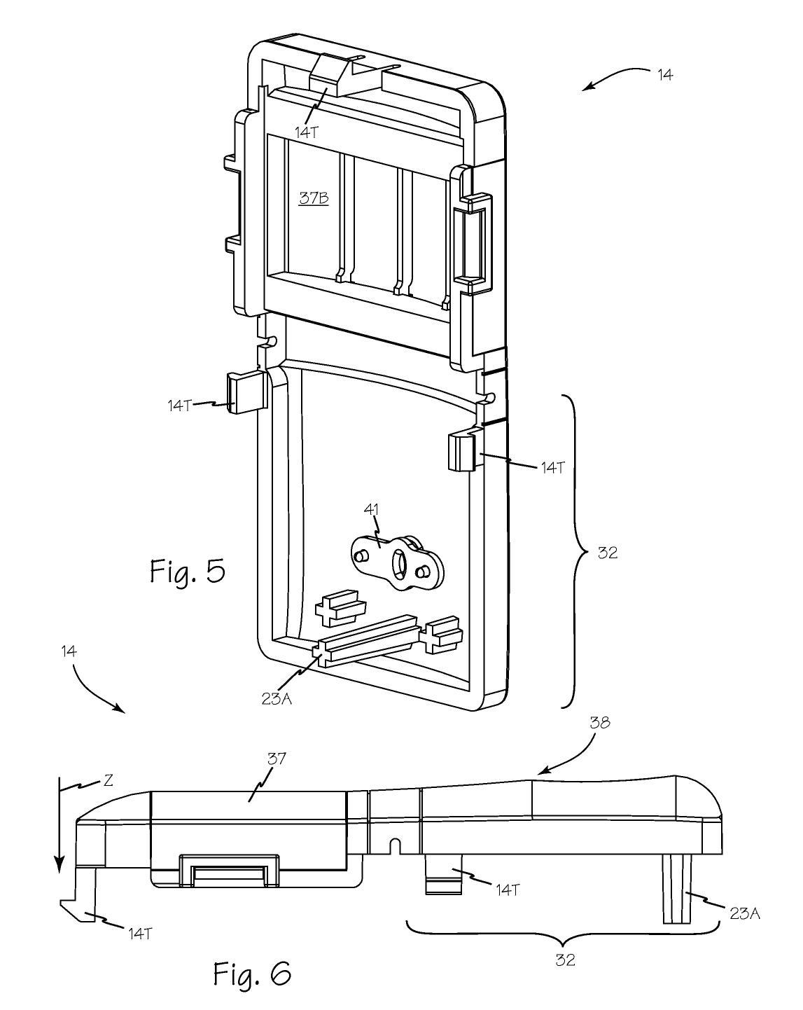

Referring now to FIGS. 5 and 6 replaceable cover plate module 14 is shown detached from base module 12 of the sensor switch assembly that would normally be installed in the switch or electrical box. To remove a cover plate module, the user merely presses in direction Z on the latch tabs 14T using finger pressure or tool, such as a small bladed screwdriver, to disengage the latch tabs from their corresponding engagement element 16L on the intermediate plate. A differently decorative cover plate module may then be attached by aligning latch tabs 14T to their corresponding engagement element 16L in the intermediate plate and pushing the cover plate 14 until the latch tabs engage the intermediate plate engagement elements 16L. The cover plate may have any number of aesthetic shapes, finishes and colors. Sensor lens or cover 37 may be colored to match or closely coordinate with the color of cover plate module 14. Overmolding techniques may be used to add textured or rubberized surfaces to areas of the cover plate module. Shapes, such as cartoon figure shapes or decorative swoops, may be molded into or applied to surface 38 of the cover plate module that may match continuations of the shapes on the wall plate 15. Colors may be applied in the same way to create decorative assemblies. To change the decorative appearance, the user removes the wall plate 15 and cover plate module 14, then replaces both components with corresponding components having a different decorative appearance. The user can also keep wall plate 15 and just replace cover plate module 14.

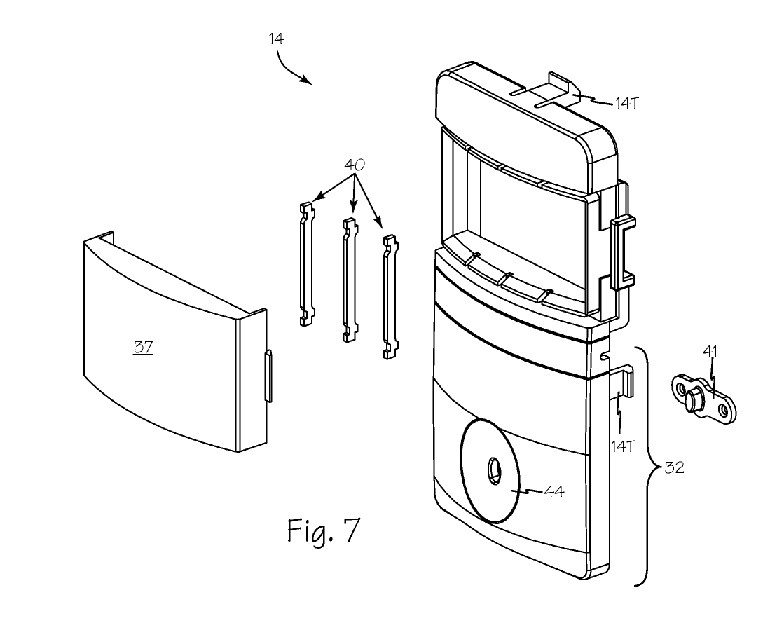

Referring now to FIG. 7. One or more support bars such as support bars 40 are attached to cover plate module 14 to provide support for sensor cover 37 which may be a PIR lens for a PIR sensor. Users may mistake sensor cover 37 for the switch and so may press on it. In the case of a PIR lens, sensor cover 37 is made fairly thin to provide adequate optical performance, so any such pressure may deform the lens or permanently damage it. The support bars provide the necessary support to reduce the chance of permanent deformation of the lens. In addition, the support bars may be designed to perform additional energy directing functions, such as guiding the infrared light to particular sections of the PIR sensor that may be used to differentiate activity in different zones of the room. Support structures such as support bars 40 may be molded directly into the sensor cover 37. Such support structures may not be needed for other vacancy/occupancy sensors with different energy characteristics, or for sensors that are mounted higher on the wall or on the ceiling where a user is much less likely to accidentally press on the lens.

Sensor cover 37 is molded of any suitable material to accommodate the energy sensing characteristics of sensor 20S. Where sensor 20S is a PIR sensor, sensor cover 37 is formed of an infrared transmissive material whose color is chosen to maximize infrared light transmission through the material. A color may be chosen that matches or complements the color of the rest of the cover plate module, but the color pigment preferably optimizes transmission of infrared light. Although sensor cover 37 is shown as a rectangular shape, it may be formed in more decorative shapes with matching or complementary shapes in cover plate module 14.

Light pipe 41 is secure to inside surface 43 of switch activator element 32 at the position of indentation 44 on the front side of switch activator element 32. Indentation 44 and the indicator light serve to identify switch activator element 32 as the push button. Light pipe 41 conducts light from any suitable indicator such as LED 20L thereby providing additional functionality. For example, indicator 20L may be used to provide illumination so that switch activator element 32 may be identified by the user in a darkened room. Indicator 20L may also be used to convey information to the user, such as the status of the load being controlled by the switch sensor or system status, such as error conditions by blinking the LED. While an LED display is shown in the preferred embodiment, any other suitable display may be provided or other display technologies, such as LCD or OLED screens, may be used with appropriate modifications to the present configuration. For example, an LCD screen may be placed underneath the push button location of the cover plate that would be accessible for changing or adjusting certain product features after the cover plate module is removed. Alternatively, the cover plate module may include a clear window through which the LCD screen may be viewed without remove the cover plate. Alternatively, an OLED display may be incorporated into switch activator element 32 with a cable or pin connection to electronics assembly 20. In this configuration, the OLED would be changed with the cover plate thereby allowing the color of the OLED (in the case of a monochrome display) to be changed with the cover plate. Such displays, color or monochrome, may be configured to display graphics that complement the decorative elements of the cover plate module and/or wall plate.

When sensor cover 37 is a PIR lens, it may adopt a Fresnel structure molded into rear surface 37R to help direct the infrared energy toward guide 16G in the intermediate plate and toward the PIR sensor 20S. Sensor cover 37 may include surface shapes or color coatings that blend with aesthetic shapes in cover plate 15, but such shaping may require special Fresnel or other optical structures and optical engineering design to ensure proper functional performance in guiding the infrared light toward the PIR sensor. Sensor cover 37 may also include different optical areas that perform separate optical functions. For example, one area may have Fresnel structures to guide light to a PIR sensor while another area may have different optical structure to guide infrared light from a remote control to an infrared receiver to provide alternative control methods.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A modular sensor switch for automatically and or manually controlling electricity to a load comprising:
a base module sized and dimensioned for mounting in a standard electrical switch box, the base module comprising:
a housing enclosing the base module;
an electronic assembly module within the housing, the electronic assembly module having a switch to enable manual control of electric energy applied to a load, at least one sensor for detecting changes in occupancy within an area of the modular sensor switch and generating one or more signals in response to changes in occupancy, and a control circuit for controlling the switch to provide automatic control of electric energy applied to the load corresponding to the one or more signals from the at least one sensor;
an intermediate plate engaging the housing, the intermediate plate securing a yoke and an insulator between the intermediate plate and the electronic assembly module; and
a cover plate module detachably coupled to the base module, the cover plate module including at least one sensor lens cover and at least one switch activator element.

2. The modular sensor switch of claim 1 wherein the at least one switch activator element is a flexible cantilever.

3. The modular sensor switch of claim 1 wherein the at least one sensor lens comprises an energy directing lens.

4. The modular sensor switch of claim 3 wherein the energy directing lens is a Fresnel lens.

5. The modular sensor switch of claim 1 further comprising one of more indicators for indicating an operational mode of the modular sensor switch.

6. The modular sensor switch of claim 1 wherein the electronic assembly module further comprises a remote command transceiver and the cover plate module further comprises a command transceiver lens.

7. The modular sensor switch of claim 5 wherein the cover plate module further comprises a light conducting element for conducting light from the one or more indicators through the cover plate module.

8. The modular sensor switch of claim 1 wherein the cover plate module is configured to be removable when the base module is mounted in a standard electrical switch box.

9. The modular sensor switch of claim 1 wherein the at least one sensor is selected from the list comprising: a passive infrared detector, an infrared sensor, an audio sensor, an ultrasonic sensor and a photo sensor.
